(19) United States
(12) Patent Application Publication
(10) Pub. No.: US 2014/0292089 A1
(43) Pub. Date: Oct. 2, 2014

(54) POWER CONVERTER CAPABLE OF OUTPUTTING A PLURALITY OF DIFFERENT LEVELS OF VOLTAGES

(71) Applicant: TOSHIBA MITSUBISHI-ELECTRIC INDUSTRIAL SYS. CORP., Minato-ku (JP)

(72) Inventor: Shinzo TAMAI, Minato-ku (JP)

(73) Assignee: TOSHIBA MITSUBISHI-ELECTRIC INDUSTRIAL SYS. CORP., Minato-ku (JP)

(21) Appl. No.: 14/184,030

(22) Filed: Feb. 19, 2014

(30) Foreign Application Priority Data
Apr. 1, 2013 (JP) 2013-075902

(51) Int. Cl. H02M 7/483

(52) U.S. Cl. CPC H02M 7/483
USPC 307/82

(57) ABSTRACT

The present invention relates to a power converter including a plurality of three-level inverters each capable of outputting three different levels of voltages, and a switch circuit for selecting an output from one of the plurality of three-level inverters. Each three-level inverter includes four switch elements connected in series, two switch elements connected in series between two nodes, and two capacitors, with the two nodes being connected to each other.

### BACKGROUND OF THE INVENTION

1. Field of the Invention

The present invention relates to power converters, and particularly to a power converter capable of outputting a plurality of different levels of voltages.

2. Description of the Background Art

A power converter that converts direct current (DC) power to alternating current (AC) power by varying continuous output of DC voltages from a plurality of DC power sources during a single cycle has been proposed. This power converter converts DC power to AC power by continuously outputting a plurality of DC voltages of different potentials, rather than generating a constant pulsed voltage like an inverter having a single DC power source. Accordingly, this power converter can continuously output the plurality of DC voltages of different potentials finely without waste, to convert DC power to AC power with suppressed harmonics compared with a power converter having a single DC power source.

For example, Japanese Patent Laying-Open No. 2000-341964 discloses a multilevel inverter as the above-described power converter. According to this patent publication, the multilevel inverter includes redox flow type secondary batteries connected in series and producing multilevel terminal voltages, and an inverter unit for controlling continuous output of potentials of the multilevel terminals to produce AC power. The inverter unit includes a total of eight switching elements and six diodes, and controls the opening/closing of the switching elements in response to instructions from a control unit.

FIG. 6 is a circuit diagram illustrating a circuit configuration of a conventional power converter such as disclosed in the aforementioned patent publication. Referring to FIG. 6, a power converter 100 is a five-level inverter capable of outputting five different levels of voltages. Power converter 100 includes four DC power sources V, eight switch elements S101 to S108, and six diodes D101 to D106.

Power converter 100 has a midpoint V₀ as the middle point between four DC power sources V, midpoint V₀ having a voltage level of “0V”. Accordingly, in power converter 100, the first DC power source V on the positive potential side relative to midpoint V₀ has a voltage level of “+1V”, and the second DC power source V on the positive potential side relative to midpoint V₀ has a voltage level of “+2V”. Conversely, in power converter 100, the first DC power source V on the negative potential side relative to midpoint V₀ has a voltage level of “−1V”, and the second DC power source V on the negative potential side relative to midpoint V₀ has a voltage level of “−2V”.

Power converter 100 can output a potential having a voltage level of “+2V” from an output terminal by turning switch elements S101, S102, S103 and S104 on, and can output a potential having a voltage level of “+1V” from the output terminal by turning switch elements S102, S103, S104 and S105 on. Power converter 100 can also output a potential having a voltage level of “0V” from the output terminal by turning switch elements S103, S104, S105 and S106 on. Power converter 100 can further output a potential having a voltage level of “−1V” from the output terminal by turning switch elements S104, S105, S106 and S107 on, and can output a potential having a voltage level of “−2V” from the output terminal by turning switch elements S105, S106, S107 and S108 on. Thus, power converter 100 can output five different levels (“−2V”, “−1V”, “0V”, “+1V”, “+2V”) of voltages from the output terminal.

In power converter 100, however, when switch elements S105, S106, S107 and S108 are turned on in order to output a potential having a voltage level of “−2V” from the output terminal, diodes D102, D104 and D106 each have a voltage level of “−2V” at its anode terminal, with diode D102 having a cathode terminal connected to a voltage level of “+1V”. Therefore, a voltage corresponding to the sum of voltages of three DC power sources V is applied to diode D102. Similarly, a voltage corresponding to the sum of voltages of two DC power sources V is applied to diode D104, and a voltage corresponding to a voltage of one DC power source V is applied to diode D106.

Moreover, in power converter 100, when switch elements S101, S102, S103 and S104 are turned on in order to output a potential having a voltage level of “+2V” from the output terminal, diodes D101, D103 and D105 each have a voltage level of “+2V” at its cathode terminal, with diode D105 having an anode terminal connected to a voltage level of “−1V”. Therefore, a voltage corresponding to the sum of voltages of three DC power sources V is applied to diode D105. Similarly, a voltage corresponding to the sum of voltages of two DC power sources V is applied to diode D103, and a voltage corresponding to a voltage of one DC power source V is applied to diode D101. As such, in the multilevel inverter disclosed in the aforementioned patent publication, diodes D102 and D105 connecting the DC power sources to the switch elements are required to have a breakdown voltage three times higher than that of diodes D101 and D106, and diodes D103 and D104 are required to have a breakdown voltage two times higher than that of diodes D101 and D106, respectively. For this reason, the multilevel inverter disclosed in the aforementioned patent publication needs to employ diodes having different breakdown voltages, or to connect two or three diodes in series to increase the breakdown voltage, thus increasing the complexity of the apparatus and the difficulty in manufacturing the apparatus.

Furthermore, in the multilevel inverter disclosed in the aforementioned patent publication, increasing the number of levels of voltages to be output requires higher breakdown voltages of the diodes. This increases the complexity of the configuration of the diodes connected between the DC power sources and the switch elements, and further increases the difficulty in manufacturing the apparatus.

### SUMMARY OF THE INVENTION

An object of the present invention is to provide a power converter having an easy to manufacture configuration.

In summary, a power converter according to the present invention includes a group of serial three-level inverters including 2ⁿ three-level inverters each capable of outputting three levels of voltages connected in series, n being an integer of 1 or more, and a switch circuit for selecting an output from either one of two of the three-level inverters in the group of serial three-level inverters. The three-level inverters each include a first switch element to a fourth switch element connected in series, a fifth switch element and a sixth switch element connected in series between a first node between the first switch element and the second switch element and a second node between the third switch element and the fourth switch element, a first charge storage element connected between a third node between the second switch element and the third switch element, and the first switch element, and a second charge storage element connected between the third node and the fourth switch element. The three-level inverter is configured to be able to output three levels of voltages by a combination of on states and off states of the first switch element to the fourth switch element by connecting the third node to a fourth node between the first charge storage element and the second charge storage element. The group of serial three-level inverters includes 2ⁿ three-level inverters connected in series by repeated connection of a fifth node between the fourth switch element and the second charge storage element in one of the three-level inverters to a sixth node between the first switch element and the first charge storage element in another of the three-level inverters adjacent to the one of the three-level inverters, 2ⁿ⁻¹ switch circuits being connected to be able to select an output from either one of the two adjacent three-level inverters in the group of serial three-level inverters. When there are two or more switch circuits, the switch circuit in a following stage is connected to be able to select an output from either one of the two switch circuits connected in a previous stage, thereby providing one output.

As such, the present invention includes the group of serial three-level inverters having a plurality of three-level inverters connected in series, and the switch circuit for selecting an output from one of the plurality of three-level inverters. Accordingly, elements required to have a breakdown voltage can be concentrated on the switch circuit regardless of the number of levels of voltages to be output, thereby realizing an easy to manufacture configuration.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram illustrating a circuit configuration of a power converter according to an embodiment of the present invention.

FIG. 2 is a waveform diagram illustrating a waveform of levels of voltage output from the power converter illustrated in FIG. 1.

FIG. 3 is a circuit diagram illustrating another circuit configuration of a power converter according to the embodiment of the present invention.

FIG. 4 is a waveform diagram illustrating a waveform of levels of voltage output from the power converter illustrated in FIG. 3.

FIG. 5 is a circuit diagram illustrating another circuit configuration of a power converter according to the embodiment of the present invention.

FIG. 6 is a circuit diagram illustrating a circuit configuration of a conventional power converter.

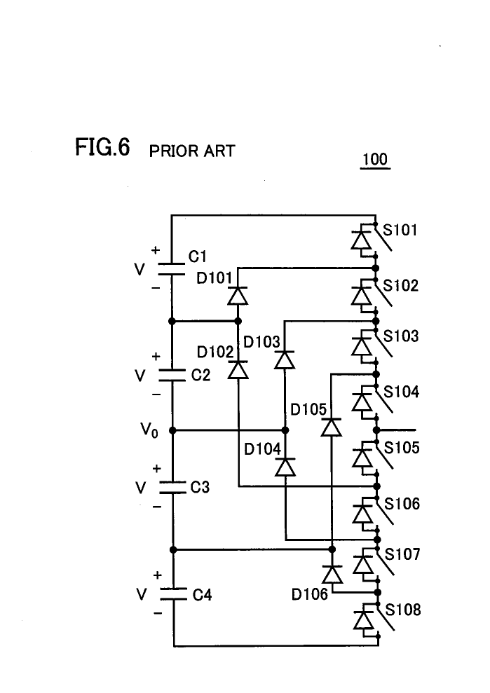

### DESCRIPTION OF THE PREFERRED EMBODIMENTS

The embodiments of the present invention will be hereinafter described in detail with reference to the drawings, in which the same or corresponding parts are designated by the same reference characters, and description thereof will not be repeated.

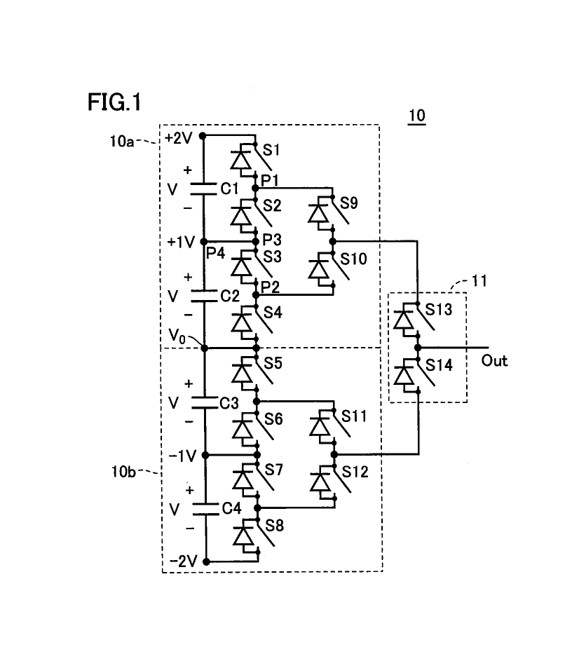

FIG. 1 is a circuit diagram illustrating a circuit configuration of a power converter according to an embodiment of the present invention. A power converter 10 illustrated in FIG. 1 is a five-level inverter capable of outputting five different levels of voltages. Power converter 10 includes four DC power sources V, fourteen switch elements S1 to S14, and an output terminal Out. It is noted that a free wheel diode is connected to each of switch elements S1 to S14.

Power converter 10 includes two three-level inverters 10a and 10b each capable of outputting three different levels of voltages, and a switch circuit 11 for selecting an output from either one of two three-level inverters 10a and 10b. Three-level inverter 10a includes four switch elements S1 to S4 connected in series, switch elements S9 and S10 connected in parallel to switch elements S2 and S3, and a capacitor C1 (first charge storage element) and a capacitor C2 (second charge storage element) serving as DC power sources V connected in series. In three-level inverter 10a, switch elements S9 and S10 are connected in series between a node P1 (first node) between switch elements S1 and S2 and a node P2 (second node) between switch elements S3 and S4. Furthermore, in three-level inverter 10a, capacitor C1 is connected between a node P3 (third node) between switch elements S2 and S3, and switch element S1, and capacitor C2 is connected between third node P3 and switch element S4. In three-level inverter 10a, node P3 is connected to a node P4 (fourth node) between capacitors C1 and C2. It is noted that three-level inverter 10b has a circuit configuration identical to that of three-level inverter 10a, with switch elements S1 to S4 corresponding to switch elements S5 to S8, switch elements S9 and S10 corresponding to switch elements S11 and S12, and capacitors C1 and C2 corresponding to capacitors C3 and C4, respectively, and therefore detailed description thereof will not be repeated.

Switch circuit 11 consists of switch elements S13 and S14, and selects an output from three-level inverter 10a or 10b when switch element S13 or S14 is turned on.

Three-level inverter 10a can output a positive-side potential of “+2V” of capacitor C1 of serially connected capacitors C1 and C2 when switch element S1 is turned on and switch element S9 is turned on. Three-level inverter 10a can output a potential of “+1V” of node P4 between serially connected capacitors C1 and C2 when switch element S2 is turned on and switch element S9 is turned on. It is noted that three-level inverter 10a can also output a potential of “+1V” of node P4 when switch element S3 is turned on and switch element S10 is turned on. Three-level inverter 10a can further output a negative-side potential of “0V” of capacitor C2 of serially connected capacitors C1 and C2 when switch element S4 is turned on and switch element S10 is turned on. Thus, three-level inverter 10a can output three levels of “0V”, “+1V” and “+2V” of voltages.

Three-level inverter 10b can operate in the same way as three-level inverter 10a, and can therefore output three levels of “0V”, “−1V” and “−2V” of voltages.

Thus, power converter 10 can output five different levels (“−2V”, “−1V”, “0V”, “+1V”, “+2V”) of voltages from output terminal Out by switching between on states and off states of switch elements S13 and S14 in switch circuit 11 to select an output from either one of three-level inverters 10a and 10b connected in series. It is noted that the negative-side potential of capacitor C2 and the positive-side potential of capacitor C3 are identical to each other, i.e., “0V”.

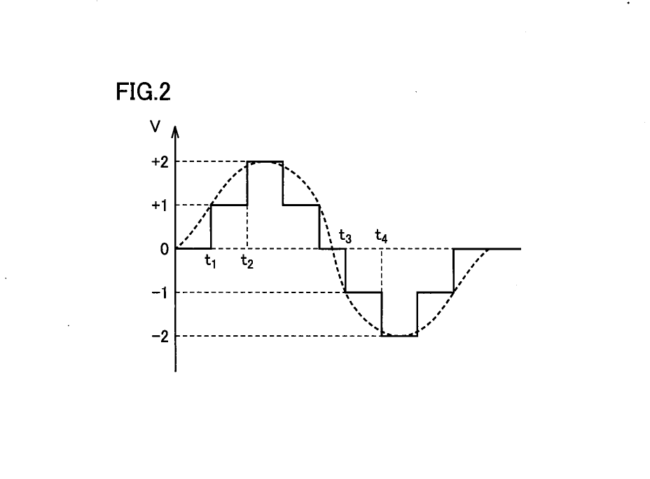

The operation of power converter 10 is now described. FIG. 2 is a waveform diagram illustrating a waveform of levels of voltage output from power converter 10 illustrated in FIG. 1.

First, power converter 10 outputs a voltage having a level of “0V” from output terminal Out by turning switch elements S4 and S10 on, and switch element S13 of switch circuit 11 on (switch element S14 is off). Then, at time t₁, power converter 10 outputs a voltage having a level of “+1V” from output terminal Out by turning switch elements S2 and S9 on, and switch element S13 of switch circuit 11 on. Alternatively, power converter 10 outputs a voltage having a level of “+1V” from output terminal Out by turning switch elements S3 and S10 on, and switch element S13 of switch circuit 11 on.

Then, at time t₂, power converter 10 outputs a voltage having a level of “+2V” from output terminal Out by turning switch elements S1 and S9 on, and switch element S13 of switch circuit 11 on. Subsequently, power converter 10 successively lowers the voltage level at output terminal Out to “+1V” and “0V”.

It is noted that power converter 10 may output a voltage having a level of “0V” from output terminal Out by turning switch elements S5 and S11 on, and switch element S14 of switch circuit 11 on.

At time t₃, power converter 10 outputs a voltage having a level of “−1V” from output terminal Out by turning switch elements S6 and S11 on, and switch element S14 of switch circuit 11 on. Alternatively, power converter 10 outputs a voltage having a level of “−1V” from output terminal Out by turning switch elements S7 and S12 on, and switch element S14 of switch circuit 11 on.

Then, at time t₄, power converter 10 outputs a voltage having a level of “−2V” from output terminal Out by turning switch elements S8 and S12 on, and switch element S14 of switch circuit 11 on. Subsequently, power converter 10 successively raises the voltage level at output terminal Out to “−1V” and “0V”.

By performing the operation of switching between the five different levels of voltages (“−2V”, “−1V”, “0V”, “+1V”, “+2V”) and outputting the voltage as described above, power converter 10 can output an AC voltage as indicated with a broken line illustrated in FIG. 2, thereby converting DC power to AC power.

In three-level inverters 10a and 10b, when component switch elements S1 to S12 are off, only a voltage corresponding to a voltage of one capacitor is applied to opposite ends of the switch elements. For example, when switch elements S1, S3 and S9 are on and switch elements S2, S4 and S10 are off, only a voltage corresponding to a voltage of capacitor C1 or C2 is applied to switch elements S2, S4 and S10 in an off state. If a voltage of “+2V” is to be output from output terminal Out, in switch circuit 11 composed of switch elements S13 and S14, switch element S13 is turned on and switch element S14 is turned off. Here, by turning switch elements S5 and S11 on, a voltage corresponding to the sum of voltages of two capacitors is applied to opposite ends of switch element S14. If a voltage of “−2V” is to be output from output terminal Out, in switch circuit 11 composed of switch elements S13 and S14, switch element S14 is turned on and switch element S13 is turned off. Here, by turning switch elements S4 and S10 on, a voltage corresponding to the sum of voltages of two capacitors is applied to opposite ends of switch element S13.

As described above, power converter 10 according to the embodiment of the present invention includes the group of serial three-level inverters having two three-level inverters 10a and 10b connected in series, and switch circuit 11. Therefore, elements to which a high voltage is applied can be limited to the elements constituting switch circuit 11. That is, power converter 10 can be manufactured simply by connecting two three-level inverters formed of available elements having a certain breakdown voltage in series, and by providing a switch circuit for selecting an output from either one of the three-level inverters, and can therefore have an easy to manufacture configuration.

It is noted that the power converter according to the embodiment of the present invention is not limited to a power converter capable of outputting five different levels of voltages. The number of levels of voltages to be output can be readily increased by increasing the numbers of three-level inverters connected in series and switch circuits.

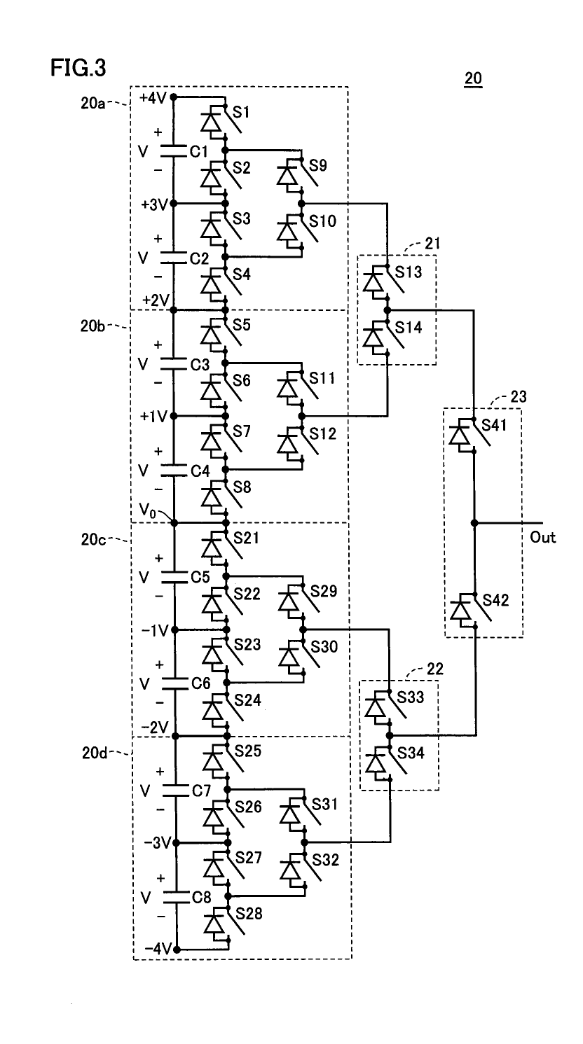

FIG. 3 is a circuit diagram illustrating another circuit configuration of a power converter according to the embodiment of the present invention. A power converter 20 illustrated in FIG. 3 is a nine-level inverter capable of outputting nine different levels of voltages. Power converter 20 includes eight DC power sources V (capacitors C1 to C8), and thirty switch elements S1 to S14, S21 to S34, S41, and S42. It is noted that a free wheel diode is connected to each of switch elements S1 to S14, S21 to S34, S41, and S42.

Power converter 20 includes a group of serial three-level inverters having four three-level inverters 20a, 20b, 20c and 20d connected in series, a switch circuit 21 for selecting an output from either one of two three-level inverters 20a and 20b, a switch circuit 22 for selecting an output from either one of two three-level inverters 20c and 20d, and a switch circuit 23 in a following stage capable of selecting an output from either one of two switch circuits 21 and 22 connected in a previous stage.

It is noted that three-level inverters 20a, 20b, 20c and 20d have a circuit configuration identical to that of three-level inverter 10a illustrated in FIG. 1, and therefore detailed description thereof will not be repeated.

Power converter 20 has a midpoint V₀ as the middle point between eight DC power sources V, midpoint V₀ having a voltage level of “0V”. Accordingly, nodes between the four DC power sources V on the upper side of midpoint V₀ have levels of “+1V”, “+2V” and “+3V” of voltages successively from the side closer to midpoint V₀, and nodes between the four DC power sources V on the lower side of midpoint V₀ have levels of “−1V”, “−2V” and “−3V” of voltages successively from the side closer to midpoint V₀. In addition, a node between DC power source V and switch element S1 has a voltage level of “+4V”, and a node between DC power source V and switch element S18 has a voltage level of “−4V”.

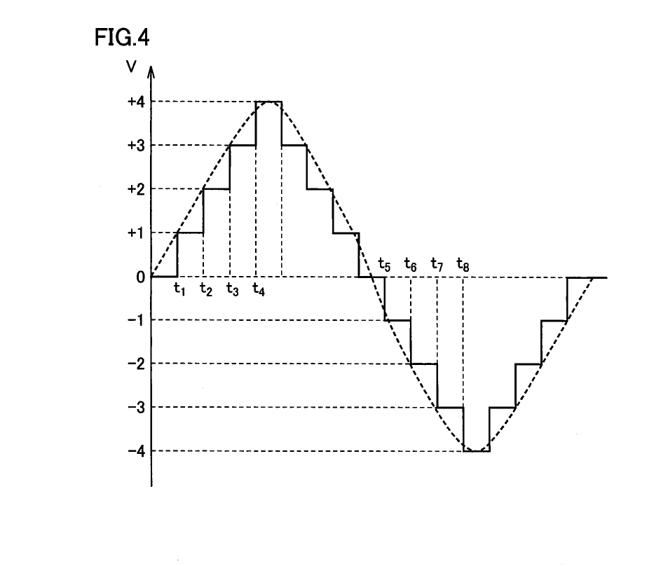

The operation of power converter 20 is now described. FIG. 4 is a waveform diagram illustrating a waveform of levels of voltages output from power converter 20 illustrated in FIG. 3.

First, power converter 20 outputs a voltage having a level of “0V” from output terminal Out by turning switch elements S8 and S12 on, switch element S14 of switch circuit 21 on, and switch element S41 of switch circuit 23 on. Then, at time t₁, power converter 20 outputs a voltage having a level of “+1V” from output terminal Out by turning switch elements S6 and S11 on, switch element S14 of switch circuit 21 on, and switch element S41 of switch circuit 23 on. Alternatively, power converter 20 outputs a voltage having a level of “+1V” from output terminal Out by turning switch elements S7 and S12 on, switch element S 14 of switch circuit 21 on, and switch element S41 of switch circuit 23 on.

Then, at time t₂, power converter 20 outputs a voltage having a level of “+2V” from output terminal Out by turning switch elements S5 and S11 on, switch element S14 of switch circuit 21 on, and switch element S41 of switch circuit 23 on.

It is noted that power converter 20 may output a voltage having a level of “+2V” from output terminal Out by turning switch elements S4 and S10 on, switch element S13 of switch circuit 21 on, and switch element S41 of switch circuit 23 on.

Then, at time t₃, power converter 20 outputs a voltage having a level of “+3V” from output terminal Out by turning switch elements S2 and S9 on, switch element S13 of switch circuit 21 on, and switch element S41 of switch circuit 23 on. Alternatively, power converter 20 outputs a voltage having a level of “+3V” from output terminal Out by turning switch elements S3 and S10 on, switch element S13 of switch circuit 21 on, and switch element S41 of switch circuit 23 on.

Then, at time t₄, power converter 20 outputs a voltage having a level of “+4V” from output terminal Out by turning switch elements S1 and S9 on, switch element S13 of switch circuit 21 on, and switch element S41 of switch circuit 23 on. Subsequently, power converter 20 successively lowers the voltage level at output terminal Out to “+3V”, “+2V”, “+1V” and “0V”.

It is noted that power converter 20 may output a voltage having a level of “0V” from output terminal Out by turning switch elements S21 and S29 on, switch element S33 of switch circuit 22 on, and switch element S42 of switch circuit 23 on.

At time t₅, power converter 20 outputs a voltage having a level of “−1V” from output terminal Out by turning switch elements S22 and S29 on, switch element S33 of switch circuit 22 on, and switch element S42 of switch circuit 23 on. Alternatively, power converter 20 outputs a voltage having a level of “−1V” from output terminal Out by turning switch elements S23 and S30 on, switch element S33 of switch circuit 22 on, and switch element S42 of switch circuit 23 on.

Then, at time t₆, power converter 20 outputs a voltage having a level of “−2V” from output terminal Out by turning switch elements S24 and S30 on, switch element S33 of switch circuit 22 on, and switch element S42 of switch circuit 23 on.

It is noted that power converter 20 may output a voltage having a level of “−2V” from output terminal Out by turning switch elements S25 and S31 on, switch element S34 of switch circuit 22 on, and switch element S42 of switch circuit 23 on.

Then, at time t₇, power converter 20 outputs a voltage having a level of “−3V” from output terminal Out by turning switch elements S26 and S31 on, switch element S34 of switch circuit 22 on, and switch element S42 of switch circuit 23 on.

Alternatively, power converter 20 outputs a voltage having a level of “−3V” from output terminal Out by turning switch elements S27 and S32 on, switch element S34 of switch circuit 22 on, and switch element S42 of switch circuit 23 on.

Then, at time t₈, power converter 20 outputs a voltage having a level of “−4V” from output terminal Out by turning switch elements S28 and S32 on, switch element S34 of switch circuit 22 on, and switch element S42 of switch circuit 23 on. Subsequently, power converter 20 successively raises the voltage level at output terminal Out to “−3V”, “−2V”, “−1V” and “0V”.

By performing the operation of switching between the nine different levels (“−4V”, “−3V”, “−2V”, “−1V”, “0V”, “+1V”, “+2V”, “+3V”, “+4V”) of voltages and outputting the voltage as described above, power converter 20 can output an AC voltage as indicated with a broken line illustrated in FIG. 4, thereby converting DC power to AC power.

In power converter 20, as in power converter 10 illustrated in FIG. 1, when component switch elements S1 to S32 are off in three-level inverters 20a, 20b, 20c and 20d, only a voltage corresponding to a voltage of one capacitor is applied to opposite ends of the switch elements.

If a voltage of “+4V” is to be output from output terminal Out, in switch circuit 21 composed of switch elements S13 and S14, switch element S13 is turned on and switch element S14 is turned off. Here, by turning switch elements S5 and S11 on, switch circuit 21 can be controlled such that a voltage corresponding to up to the sum of voltages of two capacitors is applied to the opposite ends of switch element S14. Switch circuit 22 can be similarly controlled such that a voltage corresponding to up to the sum of voltages of two capacitors is applied to the opposite ends of switch element S33.

If a voltage of “+4V” or “−4V” is to be output from output terminal Out, in switch circuit 23, a voltage corresponding to the sum of voltages of four capacitors is applied to opposite ends of switch element S41 or S42. That is, switch circuit 23 can be controlled such that a voltage of up to two times the voltage applied to switch circuit 21 or 22 is applied to the opposite ends of the switch element.

As described above, in the power converter according to the embodiment of the present invention, the number of levels of voltages to be output is increased by increasing the numbers of multilevel inverters connected in series and switch circuits. This can be generalized as follows.

In other words, the power converter according to the embodiment of the present invention includes a group of serial three-level inverters having 2ⁿ three-level inverters connected in series, and a switch circuit for selecting an output from either one of two of the three-level inverters in the group of serial three-level inverters, 2ⁿ⁻¹ switch circuits being connected to be able to select an output from either one of two adjacent three-level inverters in the group of serial three-level inverters. When there are two or more switch circuits, the switch circuit in a following stage is connected to be able to select an output from either one of the two switch circuits connected in a previous stage, thereby providing one output from the power converter.

Although the power converter according to the embodiment of the present invention has been described by limiting the number of selections of levels of voltages during a single AC cycle for the purpose of simplifying the explanation of the switching operation, a smoother AC voltage can be output by selecting levels of voltages a plurality of times by performing the switching operation a plurality of times during a single AC cycle, thereby providing a power converter with suppressed harmonics.

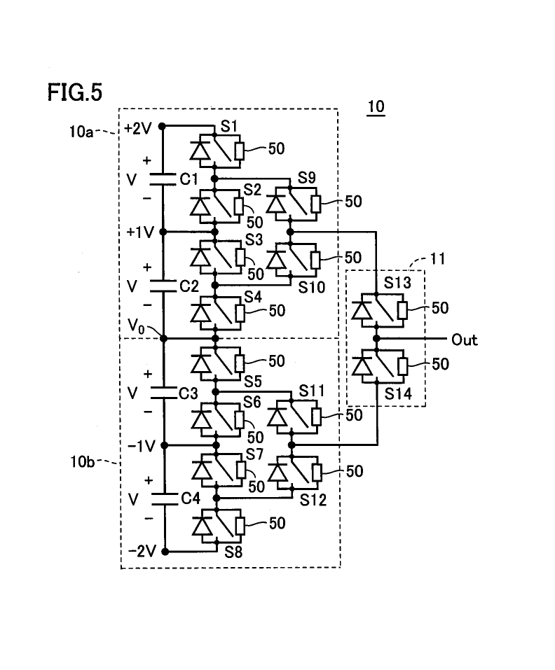

Although the power converter according to the embodiment of the present invention includes capacitors as charge storage elements, this is not intended to be limiting, and DC power sources may be connected, for example, as illustrated in FIG. 5.

Although the capacitors are directly coupled to the switch elements in the power converter according to the embodiment of the present invention, this is not intended to be limiting, and snubber circuits 50 for suppressing a sudden current variation in transition between on and off of the switch elements may be provided, for example, as illustrated in FIG. 5.

It should be understood that the embodiments disclosed herein are illustrative and non-restrictive in every respect. The scope of the present invention is defined by the terms of the claims, rather than the description of the embodiments above, and is intended to include any modifications within the scope and meaning equivalent to the terms of the claims.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A power converter comprising:
a group of serial three-level inverters including 2ⁿ three-level inverters each capable of outputting three levels of voltages connected in series, n being an integer of 1 or more; and
a switch circuit for selecting an output from either one of two of said three-level inverters in said group of serial three-level inverters,
said three-level inverters each including
a first switch element to a fourth switch element connected in series,
a fifth switch element and a sixth switch element connected in series between a first node between said first switch element and said second switch element, and a second node between said third switch element and said fourth switch element,
a first charge storage element connected between a third node between said second switch element and said third switch element, and said first switch element, and
a second charge storage element connected between said third node and said fourth switch element,
said three-level inverter being configured to be able to output three levels of voltages by a combination of on states and off states of said first switch element to said fourth switch element by connecting said third node to a fourth node between said first charge storage element and said second charge storage element,
said group of serial three-level inverters including 2ⁿ said three-level inverters connected in series by repeated connection of a fifth node between said fourth switch element and said second charge storage element in one of said three-level inverters to a sixth node between said first switch element and said first charge storage element in another of said three-level inverters adjacent to said one of said three-level inverters,
2ⁿ⁻¹ said switch circuits being connected to be able to select an output from either one of the two adjacent said three-level inverters in said group of serial three-level inverters,
when there are two or more said switch circuits, said switch circuit in a following stage being connected to be able to select an output from either one of two said switch circuits connected in a previous stage, thereby providing one output.

2. The power converter according to claim 1, further comprising a snubber circuit for suppressing a sudden current variation between said first switch element or said second switch element and said first charge storage element, and between said third switch element or said fourth switch element and said second charge storage element.

3. The power converter according to claim 1, wherein
the on states or the off states of said first switch element to said fourth switch element are selected such that, to said switch circuits for selecting an output from either one of the two adjacent said three-level inverters, a voltage equal to or less than a sum of a voltage of said first charge storage element and a voltage of said second charge storage element is applied, and to said switch circuit for selecting an output from either one of two said switch circuits connected in said previous stage, a voltage equal to or less than two times the voltage applied to said switch circuits connected in said previous stage is applied.
